(19) United States
(12) Patent Application Publication
(10) Pub. No.: US 2006/0015902 A1
(43) Pub. Date: Jan. 19, 2006

(54) Viewing history recording method and viewing history use method

(75) Inventors: Satoshi Matsuura, Kyoto (JP); Hiroshi Kutsumi, Osaka (JP); Atsushi Yoshida, Osaka (JP); Shoichi Araki, Osaka (JP)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 10/534,933

(22) PCT Filed: Nov. 13, 2003
(86) PCT No.: PCT/JP03/14484

§ 371 Date: May 13, 2005

(30) Foreign Application Priority Data
Nov. 14, 2002 (JP) 2002-330892

(51) Int. Cl. H04N 7/16; H04H 9/00; H04N 5/445

(52) U.S. Cl. 725/46; 725/9; 725/14

(57) ABSTRACT

In electric appliances (11) such as a digital TV and the like, a device agent (20) records viewing-and-listening date and time, a media type identifier and a content identifier in a group as viewing-and-listening history data. In server system (12), a user agent (30) receives viewing-and-listening history data from the device agent (20) and registers the viewing-and-listening history data in a viewing-and-listening history database. Each of external service concierges (40) and (50) accesses the server system (12) and collectively utilizes content viewing-and-listening histories in the electric appliances (11) that a user owns.

### TECHNICAL FIELD

The present invention relates to a technique for collectively managing and utilizing content viewing-and-listening histories in electric appliances connected to one another for each user or each household.

### BACKGROUND ART

Conventionally, methods for utilizing users' content viewing-and-listening histories for marketing and information recommendation have been proposed. For example, a method for recording histories of channel operation of a user using a remote controller having a PHS function and uploading the operation histories to a server through a PHS network to utilize the operation histories for an audience rating survey (see Patent Reference and, specifically, FIG. 1), a system for collectively viewing-and-listening histories to a plurality of information sources such as TV and the Internet and recommending contents that match preferences of a user (see Patent Reference 2 and, specifically, FIG. 2), and the like have been introduced. Moreover, there has been also proposed a system for transmitting, by means of a remote controller for controlling a plurality of electric appliances, user's usage histories of each of the electric appliances to a server through a communication network (see Patent Reference 3).
(Patent Reference 1) Japanese Laid-Open Publication No. 2002-77436
(Patent Reference 2) Japanese Laid-Open Publication No. 11-7453
(Patent Reference 3) Japanese Laid-Open Publication No. 2002-203168
   Problems that the Invention is to Solve

Many known techniques, however, have been applied to a single media by means of collecting viewing-and-listening histories of TV programs at a collection center, or a single appliance for dealing with a plurality of media, such as a TV for utilizing Internet browsing histories to recommend TV programs.

In future, appliances are expected to be networked furthermore. Therefore, it is desired to standardize content viewing-and-listening histories of a plurality of appliances owned by a user to achieve utilization of the standardized viewing-and-listening histories for user preference analysis or some other marketing survey, content recommendation, or some other service.

In a general method for estimating user's preferences from content viewing-and-listening histories, preferences of the user are judged by converting, using attribute information (meta-information) of contents represented by an electric program guide (EPG), content viewing-and-listening histories of a user into statistical data at a meta-information level to indicate what type of contents the user likes to watch, i.e., “what genre the user prefers” or “what keyword are contained in contents that the user prefers”.

However, a genre, a vocabulary set used as keywords, and the degree of detail of information in meta-information such as an EPG differ among different providers which provide meta-information. Therefore, assume that content viewing-and-listening histories are converted into statistical data at the meta-information level by using meta-information at a terminal. In such a case, when it is intended to standardize and utilize content viewing-and-listening histories of a plurality of appliances, the consistency of the statistical data with statistical data at the meta-information level obtained by using some other meta-information in some other appliance can not be achieved.

Moreover, as a method for utilizing content viewing-and-listening histories of a plurality of appliances, a method in which content viewing-and-listening histories are inquired of each of the appliances through a network as necessary can be used. However, it is not realistic to assume that each of all appliances is powered at all the time and can respond to an access from the network.

Moreover, in a known method, for example, as in Patent Reference 3, a single role (recording of histories, collection and management of histories or analysis of histories) is fixed for each system. Thus, it has not been possible to make a single system have a plurality of roles, and to standardize the mechanism for utilizing viewing-and-listening histories between services incorporated in electric appliances and services provided through the Internet. That is, the known method is not flexible.

Furthermore, conventionally, in most known methods, viewing-and-listening histories are provided in the same data format as the data format used when the viewing-and-listening histories have been stored. Thus, an efficient access to viewing-and-listening histories has not been necessarily achieved.

In view of the problems described above, it is therefore an object of the present invention to make it possible to integrally manage content viewing-and-listening histories in appliances of a user and to flexibly and efficiently provide services utilizing the content viewing-and-listening histories.

### DISCLOSURE OF INVENTION

Specifically, the present invention is directed to a method for recording content viewing-and-listening history data in an electric appliance used for viewing and listening to contents. The method includes the steps of: interpreting an operation performed to the electric appliance by a user and extracting a content viewing-and-listening operation; acquiring a content identifier for contents according to the extracted content viewing-and-listening operation; and specifying viewing-and-listening date and time for the contents from the extracted content viewing-and-listening operation and recording the specified viewing-and-listening date and time and the content identifier in a group as viewing-and-listening history data in a viewing-and-listening history storage section.

Moreover, the present invention is directed to a method for utilizing content viewing-and-listening histories in a plurality of appliances. The method includes the steps of: extracting, from content viewing-and-listening history data for contents specified by a common identifier in the plurality of appliances, a series of operation patterns performed to contents having the same identifier in the plurality of appliances; specifying, from the extracted operation patterns, an operation pattern commonly performed to contents having a common attribute; and creating an operation reproduction script for applying the specified operation pattern to other contents having the attribute.

Moreover, in an embodiment, the present invention is directed to a network system used for viewing and listening to contents. The network system includes at least an electric appliance including a device agent and a server system connected to the electric appliance through a network and including a user agent. The device agent includes a viewing-and-listening history storage section for storing content viewing-and-listening history data, specifies viewing-and-listening date and time for each content and records the specified viewing-and-listening date and time, a media type identifier for specifying a type of a media for the content and a content identifier for uniquely identifying the content in the specified media in a group as viewing-and-listening history data in the viewing-and-listening history storage section. The user agent includes a viewing-and-listening history database for storing content viewing-and-listening history data, receives viewing-and-listening history data from the device agent of the electric appliance and registers the viewing-and-listening history data in the viewing-and-listening history database.

According to this embodiment, in an electric appliance, the device agent records viewing-and-listening date and time, a media type identifier and a content identifier in a group as viewing-and-listening history data for each content. The media identifier specifies the type of a media for the content. The content identifier uniquely specifies the content in the specified media. In the server system, the user agent receives viewing-and-listening history data from the device agent of the electric appliance and registers the viewing-and-listening history data in the viewing-and-listening history database. Thus, in the viewing-and-listening history database of the server system, viewing-and-listing date and time, a media type identifier and a content identifier for each content viewed and listened to by at least an electric appliance are stored. That is, content viewing-and-listening histories are stored using a media identifier and a content identifier, so that interoperability between the service side and the viewing-and-listening storage side can be increased.

Moreover, according to another embodiment, the present invention is directed to a method for managing content viewing-and-listening histories in a system including at least an electric appliance used for viewing and listening to contents and a server system connected to the electric appliance through a network. In the method, the appliance specifies viewing-and-listening date and time for each content, records the specified viewing-and-listening date and time, a media type identifier for specifying the type of a media for the content and a content identifier for uniquely specifying the content in the specified media in a group as viewing-and-listening history data in the viewing-and-listening history storage section, and the server system receives viewing-and-listening history data from the electric appliance and registers the received viewing-and-listing history data in the viewing-and-listening history database.

According to this embodiment, the electric appliance records viewing-and-listening date and time, a media type identifier and a content identifier in a group as viewing-and-listening history data for each content. The media identifier specifies the type of a media for the content. The content identifier uniquely specifies the content in the specified media. The server system receives viewing-and-listening history data from the electric appliance and registers the viewing-and-listening history data in the viewing-and-listening history database. Thus, in the viewing-and-listening history database of the server system, viewing-and-listening history database, viewing-and-listening history date and time, a media type identifier and a content identifier for each content viewed and listened to by at least an electric appliance are stored. That is, content viewing-and-listening histories are stored using a media identifier and a content identifier, so that interoperability between the service side and the viewing-and-listening storage side can be increased.

In the viewing-and-listening history management method, it is preferable that an application server located outside the system accesses the server system, obtains viewing-and-listening history data from the viewing-and-listening history database and performs analysis for content viewing-and-listening.

Moreover, in another embodiment, a device agent provided in an electric appliance used for viewing and listening to contents includes a viewing-and-listening history storage section for storing content viewing-and-listening history data, an operation input interpretation section for interpreting an operation performed to the electric appliance by a user and extracting a content viewing-and-listening operation, a content ID generation section for acquiring a content identifier for contents according to the extracted content viewing-and-listening operation, and a viewing-and-listening history recording section for specifying viewing-and-listening date and time for the contents from the extracted content viewing-and-listening operation and registers the specified viewing-and-listening date and time and the content identifier in a group as viewing-and-listening history data in the viewing-and-listening storage section.

It is preferable that the content ID generation section in the device agent extracts the content identifier from a media storage in which the contents are stored or generates the content identifier from attribute information for a media according to the contents by a predetermined method.

Moreover, it is preferable that the device agent includes a viewing-and-listening history transmission section for transmitting, when the viewing-and-listening history data reaches a predetermined amount or when a request for transmission is given from the outside of the electric appliance, the viewing-and-listening history data stored in the viewing-and-listening history storage section to the outside of the electric appliance at a predetermined timing.

Moreover, in another embodiment, a user agent provided in a server system connected through a network to at least an electric appliance which a user owns or a user is authorized to use includes a viewing-and-listening history database for storing content viewing-and-listening history data of at least a media type in a format in which a media type of contents can be specified, a viewing-and-listening history receiving section for receiving viewing-and-listening history data transmitted from the electric appliance and a viewing-and-listening registration section for registering the received viewing-and-listening history data in the viewing-and-listening history database.

It is preferable that the user agent includes an inquiry receiving section for receiving an inquiry for viewing-and-listening history data, a response creation section for performing a search in the viewing-and-listening history database according to the received inquiry while taking restrictions on disclosure of viewing-and-listening histories into consideration and creating a response to the inquiry, and a response transmission section for transmitting the created response back to a subject that has transmitted the inquiry.

### BRIEF DESCRIPTION OF DRAWINGS

FIG. 1 is a diagram illustrating the entire configuration of a system according to an embodiment of the present invention.

FIG. 2 is a conceptual diagram illustrating a main module provided in each constituent element of FIG. 1.

FIG. 3 is a block diagram illustrating a device agent according to an embodiment of the present invention.

FIG. 4 is a flow chart showing the operation of recording content viewing-and-listening histories by the device agent of FIG. 3.

FIG. 5 is an exemplary operation interpretation table in the device agent of FIG. 3.

FIG. 6 is a table showing exemplary media type identifiers.

FIG. 7 is an illustration showing a method for generating a content identifier.

FIG. 8 is an exemplary table used for acquiring a broadcast station identifier.

FIG. 9 is a table showing exemplary viewing-and-listening history data stored in a device agent.

FIG. 10 is a flow chart showing the operation of transmitting viewing-and-listening history data by the device agent of FIG. 3.

FIG. 11 is a table showing another exemplary viewing-and-listening history data stored in a device agent.

FIG. 12 is a block diagram illustrating the configuration of a user agent according to an embodiment of the present invention.

FIG. 13 is a flow chart showing the operation of registering transmitted viewing-and-listening history data by the user agent of FIG. 12.

FIG. 14 is a table showing exemplary viewing-and-listening history data stored in a user agent.

FIG. 15 is a flow chart showing the operation of responding to an inquiry by the user agent of FIG. 12.

FIG. 16(a) is an illustration showing an inquiry message received by a user agent; and FIG. 16(b) is an illustration showing a response massage thereto.

FIG. 17 is a block diagram illustrating the configuration of a service concierge for performing marketing research.

FIG. 18 is a flow chart showing the operation of the service concierge of FIG. 17.

FIG. 19 is an illustration showing a GUI screen for accepting research conditions.

FIG. 20(a) is an illustration showing an exemplary inquiry message transmitted by the service concierge of FIG. 17; and FIG. 20(b) is an illustration showing an exemplary response message thereto.

FIG. 21 is an illustration showing an exemplary display of tally results.

FIG. 22 is a diagram illustrating the configuration of a service concierge for performing content recommendation.

FIG. 23 is a flow chart showing the operation of the service concierge of FIG. 22.

FIG. 24(a) is an illustration showing an exemplary inquiry message transmitted by the service concierge of FIG. 22; and FIG. 24(b) is an illustration showing an exemplary response message thereto.

FIG. 25 is an illustration showing an exemplary rule message to recommend contents.

FIG. 26 is an illustration describing the relationship between a program time and a viewing-and-listening time.

FIG. 27 is a flow chart showing a method for judging whether or not a program has been viewed and listened to.

FIG. 28 is an illustration describing a correspondence to a change in a program broadcast time.

FIG. 29 is a block diagram illustrating the configuration of a service concierge for providing a script used for automatic content management.

FIG. 30 is a block diagram illustrating the configuration of a device agent corresponding to the service concierge of FIG. 29.

FIG. 31 is a flow chart showing the operation of the service concierge of FIG. 29.

FIG. 32 is a table showing exemplary content viewing-and-listening history data.

FIG. 33 is a table showing exemplary meta-information of contents.

FIG. 34 is an illustration showing an exemplary screen having a user select additional functions.

### BEST MODE FOR CARRYING OUT THE INVENTION

Hereinafter, embodiments of the present invention will be described with reference to the accompanying drawings.

<Entire Configuration>

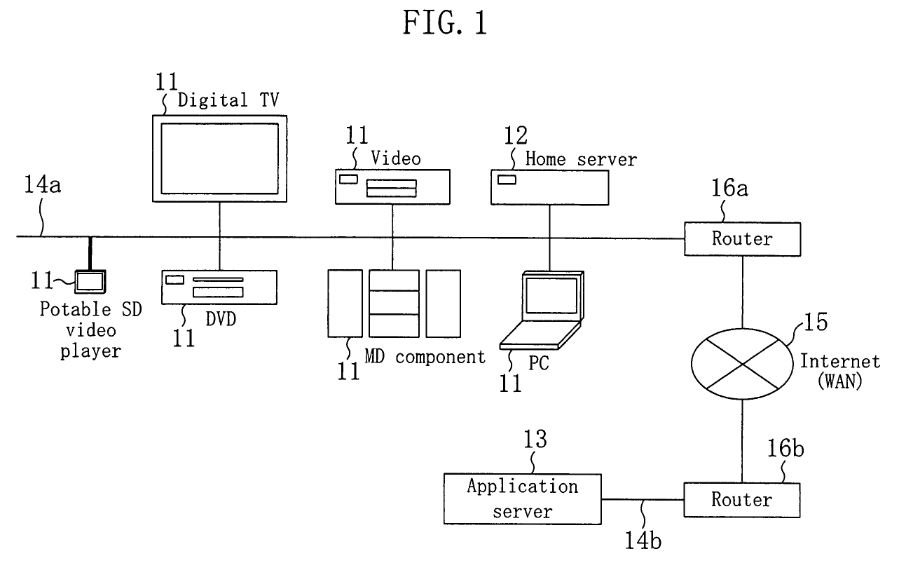

FIG. 1 is a diagram illustrating the entire configuration of a system according to an embodiment of the present invention. In FIG. 1, the reference numeral 11 denotes a terminal home-use electric appliance as an electric appliance used for viewing and listening to contents of a digital TV and a video; the reference numeral 12 denotes a server home-use electric appliance as a server system such as a home server and a home gate way to which an access from a WAN (wide area network) side is allowed according to predetermined conditions; the reference numeral 13 denotes an application server allowed to access to the server home-use electric appliance; the reference numerals 14a and 14b denote LANs (local area networks) each including a cable network such as Ethernet, a radio network represented by 802.11b or the like; the reference numeral 15 denotes WAN (the Internet); and the reference numerals 16a and 16b denote routers for connecting the LANs 14a and 14b to a WAN 15. When ADSL (asymmetric digital subscriber line) or FTTH (fiber to the home) is used in accessing to the WAN, a corresponding modem function may be provided in the routers 16a and 16b as necessary.

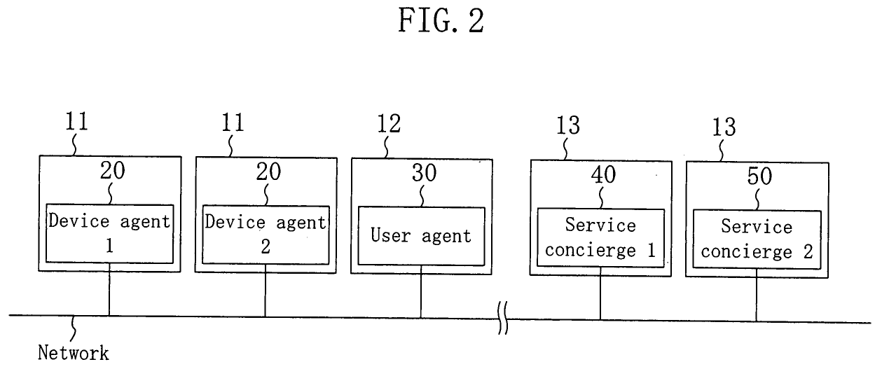

FIG. 2 is a conceptual diagram illustrating main modules provided in the terminal home-use electric appliances 11, the server home-use electric appliance 12 and the application server 13 shown in FIG. 1. As shown in FIG. 2, a device agent 20 for recording content viewing-and-listening histories due to an operation of a user as a trigger is provided in each terminal home-use electric appliance 11. Moreover, a user agent 30 for accepting content viewing-and-listening histories transmitted from the device agent 20, for example, at a predetermined timing and collectively managing the content viewing-and-listening histories is provided in the server home-use electric appliance 12. In each application server 13, provided is a service concierge 40 or 50 for providing a service using content viewing-and-listening history provided by the user agent 20.

Each of the device agent 20 and the user agent 30 is realized by combination of hardware such as CPU and a memory, and software such as a program. The terminal home-use electric appliance 11 including the device agents 20 and the server home-use electric appliance 12 including the user agent 30 together form a network according to the present invention.

In the server home-use electric device 12, such as a home server including a recoding function, of which content viewing-and-listening histories need to be recorded, in addition to the user agent 30, the device agent 20 may be provided. Moreover, if there are a plurality of home-use electric appliances each of which can be the server home-use electric device 12, a single appliance is selected as the server home-use electric appliance 12 by a predetermined method.

Moreover, a service concierge may be provided in the terminal home-use electric appliance 11 as necessary. Thus, a link application utilizing viewing-and-listening histories of some other terminal home-use electric appliance 11 can be achieved in a simple manner. For example, if a service concierge is provided in an MD component, the service of obtaining viewing-and-listening histories of a digital TV through the user agent and automatically downloading a theme song of a program that the user have watched can be achieved.

Furthermore, as a Java application of a cellular phone, a data portion (meta-information database) of the service concierge may be disposed in the application server 13 and a program portion may be downloaded to the server home-use device 12. With such a configuration, it is possible to prevent the viewing-and-listening histories from flowing on a network, so that privacy protection can be ensured.

That is, the device agent, the user agent and the service concierge may be freely disposed on electric appliances connected with one another via a network.

Next, the configuration and operation of each module shown in FIG. 2 will be described.

<Device Agent>

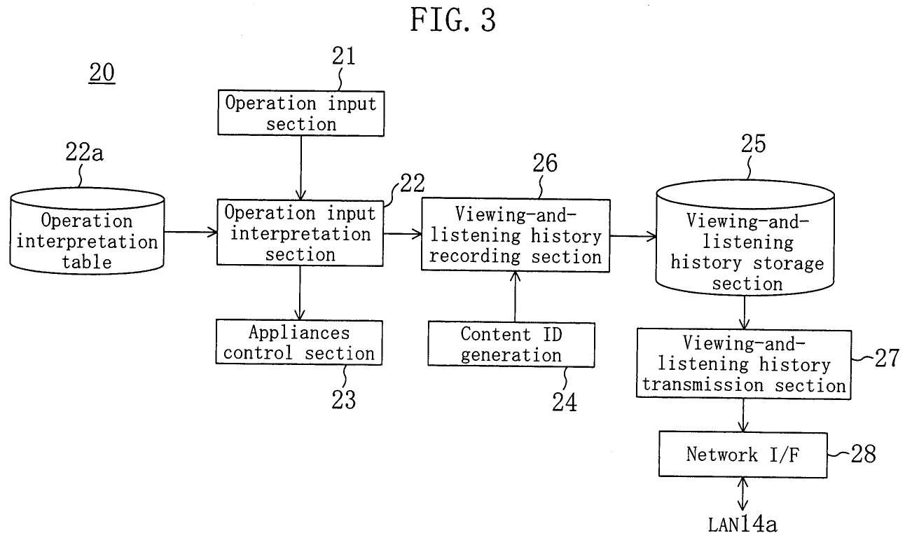

FIG. 3 is a block diagram illustrating the configuration of the device agent 20. In FIG. 3, the reference numeral 21 denotes an operation input section for accepting an operation from a user to be input via a remote controller or the like; the reference numeral 22 denotes an operation input interpretation section for interpreting an operation input from the operation input section 21 to determine an operation state of the home-use electric appliance 11 and extracting an content viewing-and-listening operation; the reference numeral 23 denotes a appliance control section for controlling the home-use electric appliance 11 according to an analysis result of the operation input analysis section 22; the reference numeral 24 denotes a content ID generation section for generating a content identifier to identify contents; the reference numeral 25 denotes a viewing-and-listening history storage section for storing content viewing-and-listening history data; the reference numeral 26 denotes a viewing-and-listening history recording section for specifying viewing-and-listening date and time from a content viewing-and-listening operation extracted by the operation input analysis section 22 and recording the specified viewing-and-listening date and time and a content identifier generated by the content ID generation section 24 in a group as viewing-and-listening history data in the viewing-and-listening history storage section; and the reference numeral 27 denotes a viewing-and-listening history transmission section for transmitting, for example, at a predetermined timing, the viewing-and-listening history data stored in the viewing-and-listening history recording section 25 to the device agent 30 via a network IF 28.

In this case, the device agent 20 of FIG. 3 is assumed to be provided in a digital TV. As content viewing-and-listening date and time, date and time when a content viewing-and-listening is started and date and time when the content viewing-and-listening is ended are recorded. Instead of the date and time when the content viewing-and-listening is ended, a time for which contents have been viewed and listened to may be recorded.

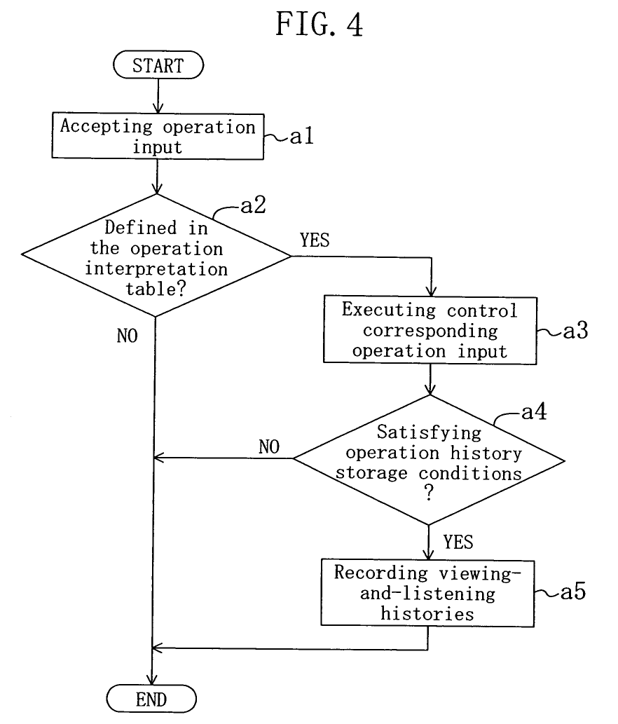

The operation of recording content viewing-and-listening histories by the device agent 20 of FIG. 3 will be described using a flow chart of FIG. 4.

(Step a1)

The operation input section 21 accepts a remote control operation from a user. In this case, assume that the user watches digital TV on Terrestrial wave broadcasting television channel 8 and has pressed a channel up button of a remote control twice. An input operation from some other device than the remote controller is also processed in the same manner.

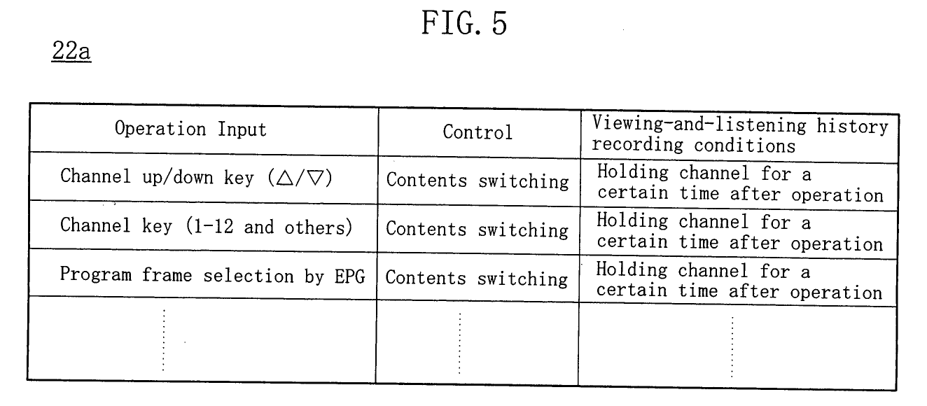

The operation input interpretation section 22 interprets the operation input accepted in the Step a1 with reference to the operation interpretation table 22a and judges whether or not the operation input is an operation relating content viewing-and-listening, i.e., a content viewing-and-listening operation. FIG. 5 is an exemplary operation interpretation table 22a. If the accepted operation input is defined in the operation interpretation table 22a (yes), it is judged that the operation input is a content viewing-and-listening operation, and the process proceeds with Step a3. On the other hand, if the accepted operation input is not defined in the operation interpretation table 22a (no), it is judged that the operation input is not a content viewing-and-listening operation, and the device agent 20 terminates the operation.

(Step a2)

In this case, the user has pressed the channel up button twice from Channel 8. This applies to a content viewing-and-listening operation and is interpreted into that “the channel has been switched to Channel 10”. Note that even when Channel 10 is directly designated by pressing not the channel up button but some other button on the remote control, or when a program on Channel 10 now on air is selected from an EPG program listing, the same interpretation is given.

(Step a3)

The appliance control section 23 executes control corresponding to the operation input. In this case, the channel is switched so as to be two channels up, i.e., Channel 10. A display switching operation may be changed according to an input operation method using the channel up button, the direct button or EPG.

(Step a4)

Whether or not the operation input satisfies operation history recording conditions described in the operation interpretation table 22a is judged. If the operation history recording conditions are satisfied (yes), the process proceeds with Step a5. On the other hand, if the operation history recording conditions are not satisfied (no), it is judged that no recording is needed, and the device agent 20 terminates the operation.

In FIG. 5, as an operation history recording condition, “the channel is held for a certain amount of time after the operation” is specified. In this case, it is assumed that the channel has been changed to Channel 10 and then the channel has been held for a certain amount of time, the process proceeds with Step a5.

(Step a5)

The viewing-and-listening history recording section 26 records viewing-and-listening history data in the viewing-and-listening history storage section 25. Specifically, in this case, it is judged that viewing-and-listening of Channel 8 is ended and viewing-and-listening of Channel 10 is started, and the viewing-and-listening history recording section 26 reads out the viewing-and-listening start date and time of Channel 8 stored in the viewing-and-listening start date and time storage section (not shown). Meanwhile, a present date and time is assumed as the viewing-and-listening date and time of Channel 8, and the viewing-and-listening start date and time, the viewing-and-listening end date and time, a media type identifier and a content identifier generated by the content ID generation section 24 are recorded as a group in the viewing-and-listening history storage section 25. At this time, the present date and time is stored as the viewing-and-listening start date and time of Channel 10 in the viewing-and-listening history storage section.

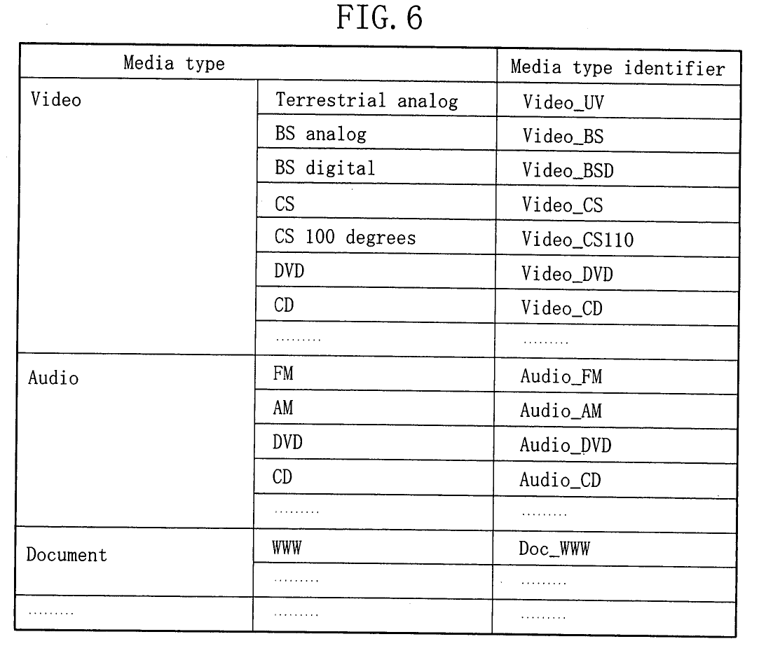

FIG. 6 is a table showing exemplary media type identifiers. To allow collective management of viewing-and-listening history data for contents, the “media type identifier” specifies the type of a media according to the contents. In this case, a program on an analog terrestrial broadcasting is viewed and listened to, and thus “Video_UV” is recorded as a media type identifier.

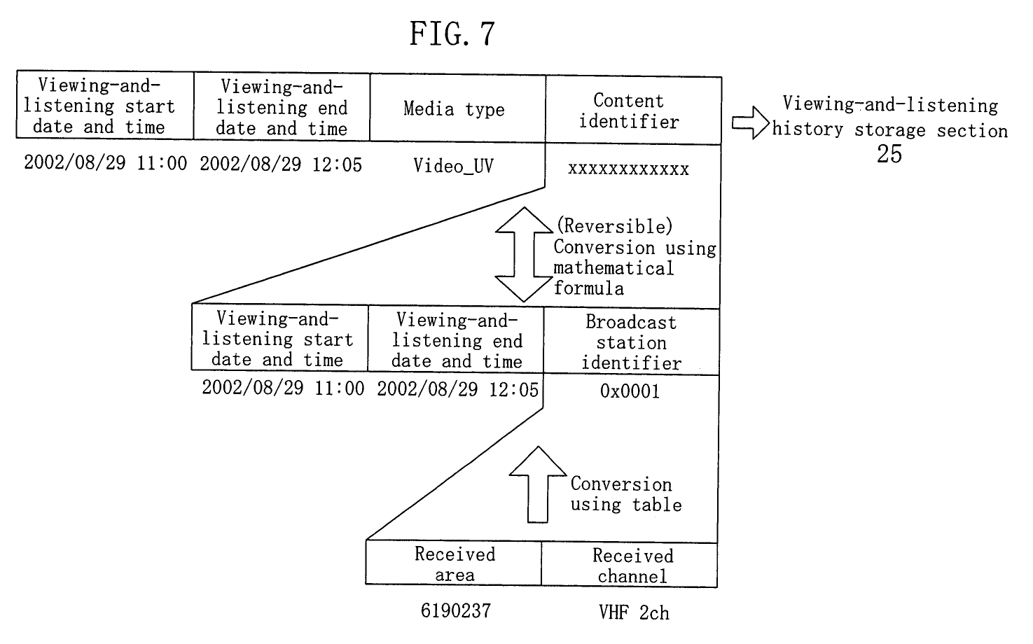

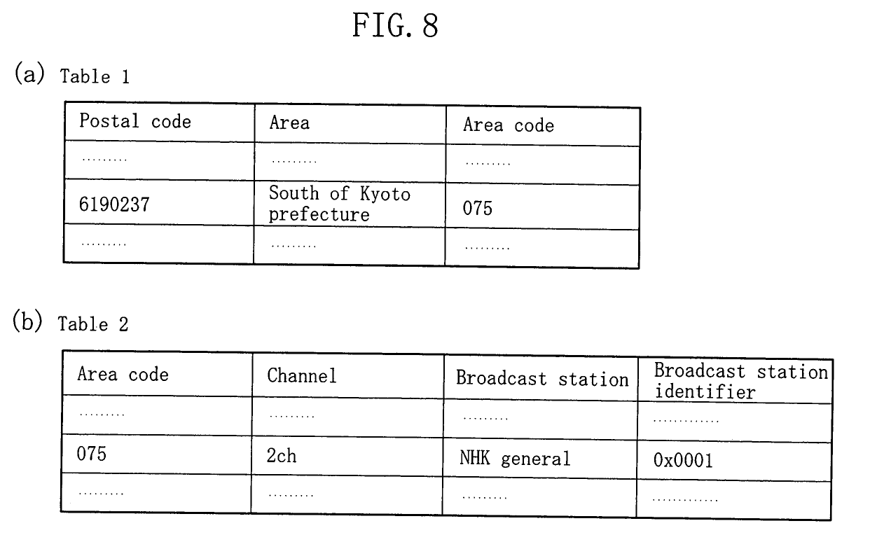

Moreover, in this case, the content identifier is generated in the manner shown in FIG. 7. The “content identifier” uniquely specifies the contents in the specified media. First, a broadcast station identifier is acquired from a code to specify an area (i.e., postal code in this case) and a received channel. In a recent appliance, such as a TV receiver and a VCR, including a tuner, channel setting is completed by only inputting a seven digit postal code for the purpose of simplifying a channel setting when the appliance is set up. In such an appliance, as shown in FIG. 8, a table (a) used for specifying an area based on a seven digit postal code and a table (b) used for determining, based on an area code, a broadcast station that should be allocated to each channel are installed. Thus, a broadcast station identifier can be acquired in a simple manner by using the tables. Note that as a code to specify an area, a telephone area code for the fixed phone line and a local number may be used in combination.

Then, using the acquired broadcast station identifier and a content viewing-and-listening date, a content identifier is generated and time according to a predetermined mathematical formula. In this case, it is assumed that a reversible conversion is performed and, by a predetermined reversible conversion, the broadcast station identifier and the viewing-and-listening date and time can be extracted from the content identifier.

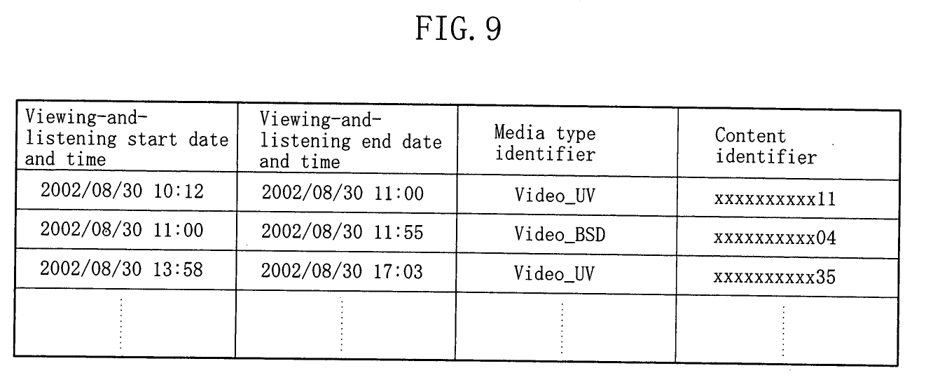

The content identifier generated in the manner described above is recorded with the viewing-and-listening date and time and the media type identifier in the viewing-and-listening history storage section 25. As a result of the operation described above, the viewing-and-listening history data shown in FIG. 9 is stored in the viewing-and-listening history storage section 25.

As for acquisition (addition) of the content identifier, various methods may be used for each type of media. As a typical method, the above-described method for generating a content identifier from attribute information according to the contents by a predetermined manner, a method for extracting a content identifier from a media storage in which the contents are stored.

For example, in TV analog terrestrial broadcasting, contents that a user has been viewed and listened to can be specified by combining three attribute information, i.e., an area from which contents have been received, a channel (e.g., VF2ch) through which the contents have been received and a time slot in which the contents have been received. The combined three attribute information can be used as a content identifier. Moreover, there is a method in which using EPG data, the name of a program and the like are taken out from the time slot in which a user has watched TV and is used as a content identifier. However, when a broadcast time is suddenly changed because a base ball game has gone into overtime and the like, there might be cases where contents and an identifier do not correspond to one another.

In digital broadcasting, a content identifier of a program can be acquired from meta-information transmitted simultaneously with program data. Moreover, in the case of a known media such as a CD a method for calculating an ID from unique information to each media such as recording time the number of tracks and the like are generally used. Furthermore, in the case of a new media such as a DVD, a method in which a content identifier recorded in advance is read out can be used.

To allow analysis of content viewing-and-listening histories in the application server side, a common identifier for each media type has to be used among a plurality of device agents and service concierges. However, this does not cause any big problem because with use of a conversion table, conversion and interoperation among different identifier systems can be achieved in a simple manner. In contrast, if conversion is performed using EPG and the like to obtain statistical data at the meta-information level, in order to achieve interoperation, a conversion table used for performing mapping among vocabulary systems used in the meta-information is required. A vocabulary space tends to be increased in nature and achievement of the mapping among vocabulary systems as well as maintenance is very difficult.

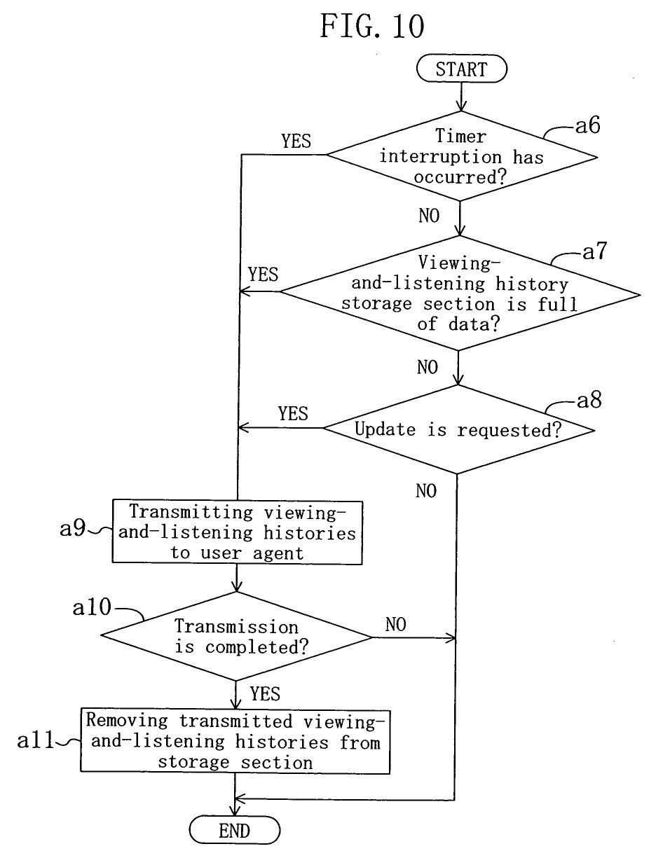

Next, the operation of transmitting viewing-and-listening history data by the device agent 20 of FIG. 3 will be described with reference to a flow chart of FIG. 10. The operation may be performed parallelly to or sequentially with the operation of storing content viewing-and-listening histories shown in FIG. 4. The user agent 30 of the server home-use electric appliance 12 receives the transmitted viewing-and-listening history data.

(Step a6)

Whether or not a timer interruption for updating viewing-and-listening histories to the user agent 30 has occurred is examined. If the interruption has occurred, the process proceeds with Step a9. On the other hand, if not so, the process proceeds with Step a7.

(Step a7)

Whether or not the viewing-and-listening history storage section 25 is full of the viewing-and-listening history data is examined. If the viewing-and-listening history storage section 25 is full, the process proceeds with Step a9. On the other hand, if not so, the process proceeds with Step a8. Note that it may be examined whether or not viewing-and-listening history data has reached a predetermined amount, instead of whether or not the viewing-and-listening history storage section 25 is full.

(Step a8)

Whether or not update of the viewing-and-listening history from the user agent 30 is requested is examined. If the update is requested, the process proceeds with Step a9. On the other hand, if not so, the operation is terminated.

(Step a9)

Content viewing-and-listening histories stored in the viewing-and-listening history storage section 25 are transmitted to the user agent 30 from the viewing-and-listening history transmission section 27 through the network I/F 28. Specifically, in Step a9, the viewing-and-listening history data is transmitted at a predetermined timing due to the timer interruption. Moreover, when the viewing-and-listening history storage section 25 becomes full of the viewing-and-listening history data, or when transmission of the viewing-and-listening history data is requested from the outside of the electric appliance, the viewing-and-listening history data is transmitted. Note that the conditions in Steps a6 through a8 are not necessary conditions but may be omitted.

(Step a10)

Whether or not the transmission is completed is confirmed. If the transmission is completed, the process proceeds with Step all. On the other hand, if not so, the operation is terminated.

(Step a11)

The transmitted viewing-and-listening history data is removed from the viewing-and-listening history storage section 25 and the operation is terminated.

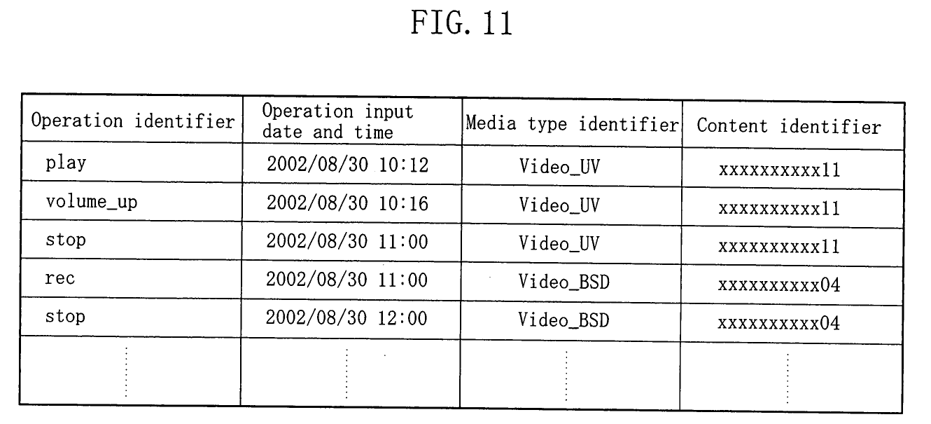

Not only the contents viewing and listening date and time but also histories of operations executed to contents may be recorded as the viewing-and-listening history data. FIG. 11 is a table showing an example of stored data in the viewing-and-listening history storage section 25 when histories of operations executed to contents as well as the date and time for contents are stored. In this case, to ensure interoperation, identifiers of operations (e.g., reproduction, recording, erasing, stopping, copying etc.) executable to contents may be standardized. By recording operation histories, what operation (e.g., storage, reproduction, erasing, etc.) is performed to what kind of contents (e.g., genre, artist, keyword, etc.) at the service concierge can be judged.

For example, the operations are:
(1) watching only stream (real-time broadcast) news for news
(2) storing variety shows in a HDD and removing each show after the show has been watched once
(3) temporarily storing TV dramas in a HDD and transferring the dramas to DVDs by titles.
   These operations can be applied to the service of automatically executing an operation sequence typical to each content for each user.

Moreover, by using the operation histories recorded by the device agency in the reverse direction, operations (storing, reproduction and removal of contents) of the device from the service concierge can be realized in a simple manner. Furthermore, by giving a request for an operation of contents (in the same format as that of operation histories) from the service concierge to the user agent, it becomes possible to make a suitable device execute the operation in response to the request.

<User Agent>

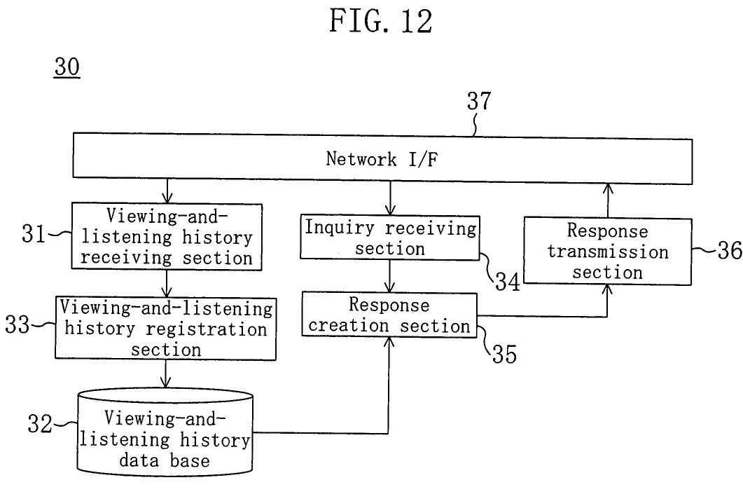

FIG. 12 is a block diagram illustrating the configuration of the user agent 30. In FIG. 12, the reference numeral 31 denotes a viewing-and-listening history receiving section for receiving viewing-and-listening history data transmitted from a device agent 20, the reference numeral 32 denotes a viewing-and-listening history database for storing viewing-and-listening history data, the reference numeral 33 denotes a viewing-and-listening history registration section for registering the viewing-and-listening history data received by the viewing-and-listening history receiving section 31 in the viewing-and-listening history database 32, the reference numeral 34 denotes an inquiry receiving section for receiving an inquiry request from the service concierge, the reference numeral 35 denotes a response creation section for performing a search in the viewing-and-listening history database 32 according to the contents of the inquiry received by the inquiry receiving section 34 and creating a response to the inquiry, and the reference numeral 36 denotes a response transmission section for transmitting the response created by the response creation section 35 to the service concierge, i.e., a subject body which has transmitted the inquiry.

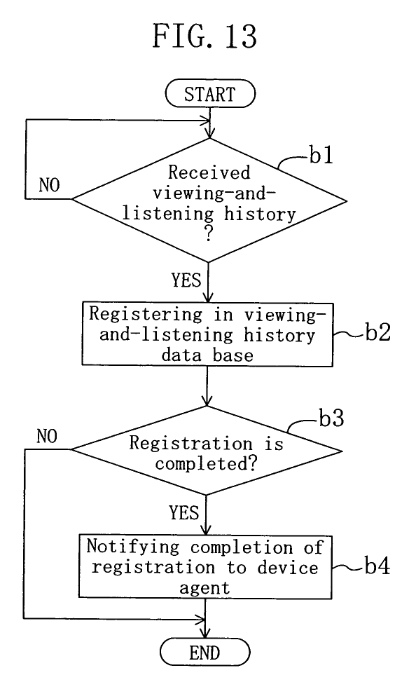

First, the operation of registering viewing-and-listening history data transmitted from the device agent 20 in the viewing-and-listening history database 32 performed by the user agent 30 will be described with reference to a flow chart of FIG. 13.

(Step b1)

The viewing-and-listening history receiving section 31 examines whether or not viewing-and-listening history data from the device agent 20 is received. If viewing-and-listening history data is received, the process proceeds with Step b2. On the other hand, if not so, an execution of Step b1 is continuously performed at predetermined intervals.

(Step b2)

The viewing-and-listening history registration section 33 takes out the viewing-and-listening history data received by the viewing-and-listening history receiving section 31 and registers the viewing-and-listening history data in the viewing-and-listening history database 32.

(Step b3)

Where or not registration of the viewing-and-listening history data into the viewing-and-listening history database 32 is normally completed is judged. If the registration is normally completed, the process proceeds with Step b4. On the other hand, if not so, the operation is terminated.

(Step b4)

A notification of completion of the registration is transmitted back to the device agent 20, i.e., the source of the viewing-and-listening history data and the operation is terminated.

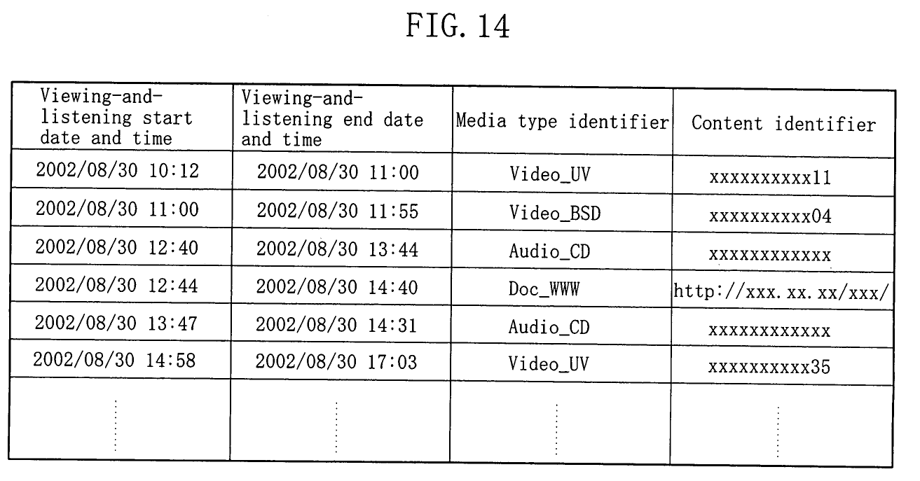

FIG. 14 is a table showing exemplary viewing-and-listening history data stored in the viewing-and-listening history database 32. In FIG. 14, the viewing-and-listening history data transmitted from each device agent 20 is stored in an order according to viewing-and-listening start dates and times.

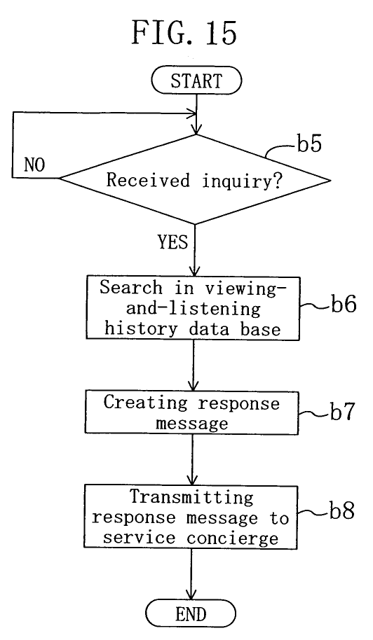

Next, the operation of responding to an inquiry from the service concierge performed by the user agent 30 of FIG. 12 with reference to a flow chart of FIG. 15. The operation is executed in parallel to the operation of registering the viewing-and-listening history data of FIG. 13.

(Step b5)

The inquiry receiving section 34 examines whether or not an inquiry from the service concierge has been received or not. If an inquiry has been received, the process proceeds with Step b6. If not, the execution of Step b5 is continuously performed at predetermined intervals. In the inquiry, predetermined communication protocol and message format are used. For example, HTTP (hyper text transfer protocol) and XML (extensive markup language) can be used as the communication protocol and the message format, respectively.

(Step b6)

The response creation section 35 performs an interpretation of the inquiry received by the inquiry receiving section 34, and then performs a search in the viewing-and-listening history database 32. In this case, the questionnaires of the inquiry are:
(1) what contents have been viewed and listened to at designated date and time?
(2) what contents have been viewed and listened to in a designated period?
(3) what contents have been viewed and listened to at designated date and time in a designated period?
(4) whether contents with a designated identifier have been viewed and listened to?
(5) when the contents with a designated identifier have been viewed and listened to?
   and the like. A search is performed according to the questionnaire of the inquiry.

(Step b7)

Search results in Step b6 are encoded into a format of a response. For example, the results for the inquiry questionnaires (1) through (5) in Step b6 are as follows.
(1) “media type identifier+content identifier”
(2) a set of “media type identifier+content identifier”
(3) a set of “media type identifier+content identifier
(4) “YES” or “NO”
(5) a set of “dates and times”
   Note that as for the format of a response message, as in the case of the format of inquiry messages, for example, a format defined by XML can be used.

As in this embodiment, by realizing an access to viewing-and-listening histories from the service provider side in terms of inquiry from the service concierge to the user agent, viewing-and-listening histories to be disclosed can be restricted according to contract coverage. That is, it is preferable that the response creation section 35 takes disclosure restriction into consideration and performs a search in the viewing-and-listening history database 32.

Conventionally, in most known systems, the viewing-and-listening histories are provided in the same data format as that used when the viewing-and-listening histories are stored. There have been very few systems in which an inquiry is prepared to allow efficient accesses to viewing-and-listening histories. Inquiry is used as a method for accessing to the viewing-and-listening histories, for example, to restrict the amount of data which can be read out at a time and a period which is required for reading out the data, so that it is possible to prevent all the viewing-and-listening histories being carefully read out. In another case, types of available inquires are limited for each service, privacy protection can be ensured. Moreover, the service provider side can extract a viewing-and-listening trend of each user only by combining inquiries. Therefore, a service using viewing-and-listening histories can be advantageously established in a simple manner.

As examples of restrictions for viewing-and-listening history disclosure, the number of inquiries can be limited, the types of inquiry contents can be limited, and the like. Also, for example, although, normally, a list of viewing-and-listening dates and times is transmitted back in response to the inquiry “when was the content of a designated identifier viewed and listened to?”, disclosure restriction may be set so that the number of viewing-and-listening of contents is transmitted back in a service.

(Step b8)

A response message created by the response creation section 35 is transmitted from the response transmission section 36 to the service concierge, i.e., the source of the inquiry message and the operation is terminated.

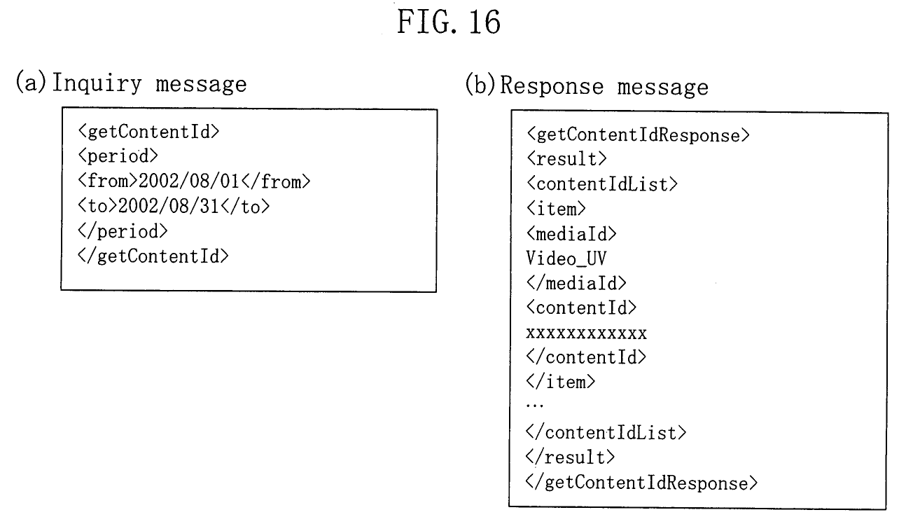

FIG. 16 is an illustration showing exemplary inquiry and response messages. Each of the inquiry and response messages is described in XML. The inquiry message of FIG. 16(a) is an inquiry for contents viewed and listened to from the 1 Aug., 2002 to the 31 Aug., 2002. FIG. 16(b) shows a response message corresponding to the inquiry message.

By the operation described above, viewing-and-listening date and time, a media type identifier and a content identifier for each content viewed and listened to by at least one terminal home-use electric appliance 11 are stored in the viewing-and-listening history database 32 of the server home-use electric appliance 12. Specifically, content viewing-and-listening histories in the terminal home-use electric appliance 11 that a user owns can be collectively managed in the server home-use electric appliance 12. Accordingly, each of the service concierges 30 and 40 can use content viewing-and-listening histories in the terminal home-use electric appliance 11 in a collective manner only by accessing to the server home-use electric appliance 12.

It should be noted that in this embodiment, the electric appliances and server systems are set up in a household. However, even if the electric appliances and server systems are set up in some other place than a household, for example, at an office or in a school, the present invention is effective.

It should be noted that in the operation of the device agent 20, when content viewing-and-listening histories of a single media is managed, addition of the media type identifier may be omitted.

<Service Concierge>

(Case 1: Marketing Research)

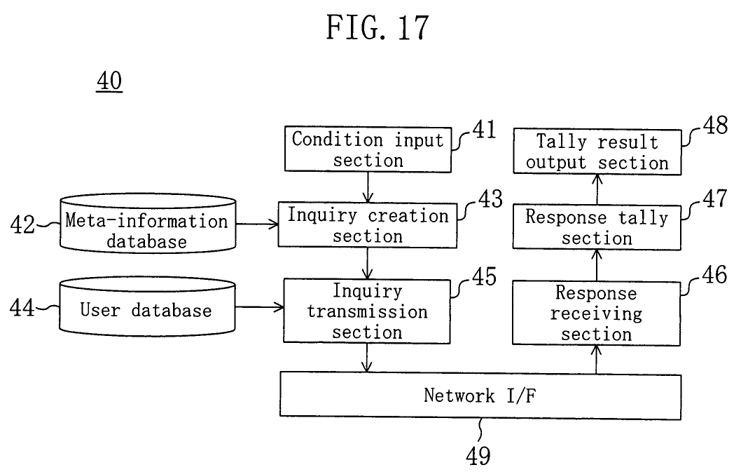

FIG. 17 is a block diagram illustrating the configuration of the service concierge 40 for conducting marketing research. In FIG. 17, the reference numeral 41 denotes a condition input section for accepting research conditions including a vocabulary at the meta-information level, such as program titles and artist names; the reference numeral 42 denotes a meta-information database in which meta-information such as attribute data of contents is stored for each media type so that each meta-information corresponds to a content identifier; the reference numeral 43 denotes an inquiry creation section for replacing, with reference to the meta-information database 42, the vocabulary at the meta-information level included in the inquiry received from the condition input section 41 with a content identifier, a viewing-and-listening time and the like to create an inquiry message to the user agent 30; the reference numeral 44 denotes a user database in which a profile (attribute information) of a user having a contract to use a service provided by the service concierge, location information (network address) of the user agent 30 and location information of the terminal home-use electric appliance for receiving services; the reference numeral 45 denotes an inquiry transmission section for transmitting the inquiry message created by the inquiry creation section 43 to the user agent 30 of a contract user; the reference numeral 46 denotes a response receiving section for receiving a response message from the user agent 30; the reference numeral 47 denotes a response tally section for tallying response messages received by the response receiving section 46; and the reference numeral 48 denotes a tally result output section for outputting a tally result of the response tally section 47.

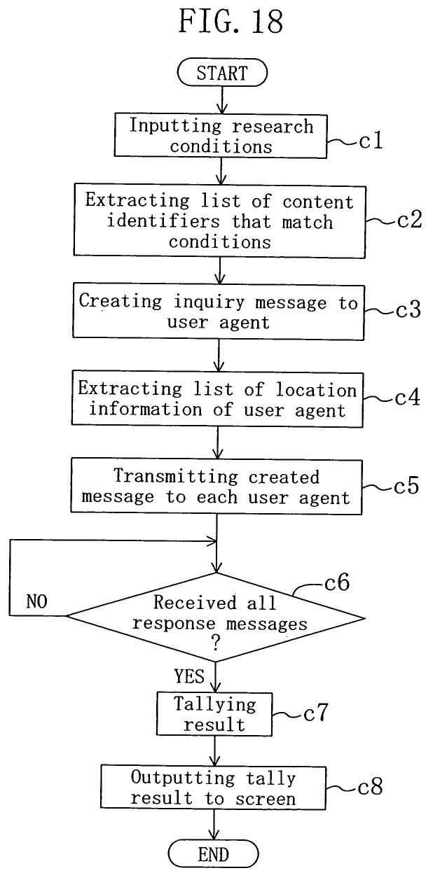

The operation of the service concierge 40 of FIG. 17 will be described with reference to a flow chart of FIG. 18. In this case, as marketing research, a ranking for dramas broadcasted on terrestrial broadcast channels in the week from the 5 Aug., 2002 to the 11 Aug., 2002 are obtained.

(Step c1)

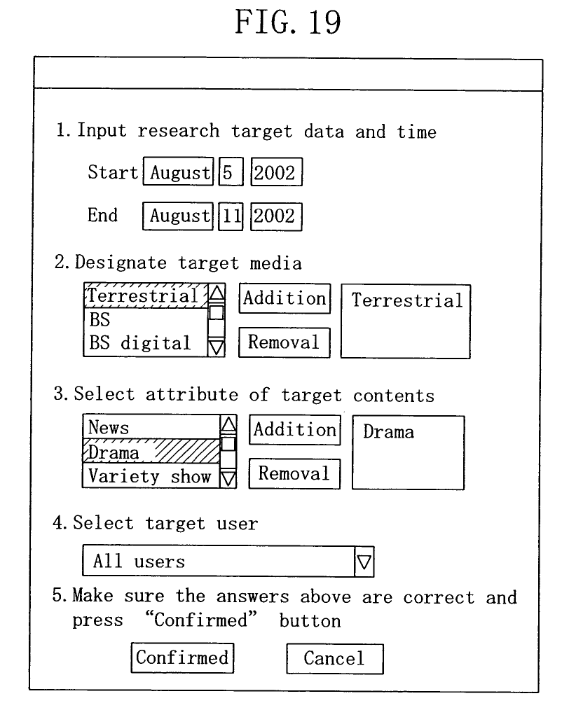

The condition input section 41 displays a GUI of FIG. 19 on a display screen and accepts research conditions. In this case, the week “from the 5 Aug., 2002 to the 11 Aug., 2002” is designated as a research period, “terrestrial broadcasting” is selected for a search target, and “drama” is selected for a genre. Moreover, “ranking” is designated for result output format (not shown).

(Step c2)

Under the conditions input in Step c1, i.e., “dramas” broadcasted on the “terrestrial broadcasting” “from the 5 Aug., 2002 to the 11 Aug., 2002”, a search is performed in the meta-information database 42 and content identifiers of programs matching the conditions are extracted as a list.

(Step c3)

The inquiry creation section 43 creates a message to inquire of the user agent 30 whether or not contents on the list extracted in Step c2 has been viewed and listened to.

(Step c4)

The inquiry transmission section 45 extracts a list of the location information (network address to which information is to be transmitted) of the user agent 30 registered in the user database 44.

(Step c5)

The inquiry transmission section 45 transmits the inquiry message created in Step c3 to each user agent 30 with reference to the list extracted in Step c4. When a research targeting users of a specific profile is desired to be performed, profile conditions, for examples, sex, generation (age), family structure, and the like of a user as a target of the research can be designated in the condition input section 41. After the profile conditions for the user have been designated, the inquiry transmission section 45 extracts only a location information of the user agent of the user matching the profile conditions from the user database 44 and an inquiry message is transmitted. Thus, only data for the user to be a research target can be collected.

(Step c6)

The response receiving section 46 examines whether or not all of response messages transmitted from the user agent 30 to which an inquiry message has been transmitted have been received. If all of the response messages have been received, the process proceeds with Step c7. On the other hand, if not so, Step c6 is executed again with a predetermined interval.

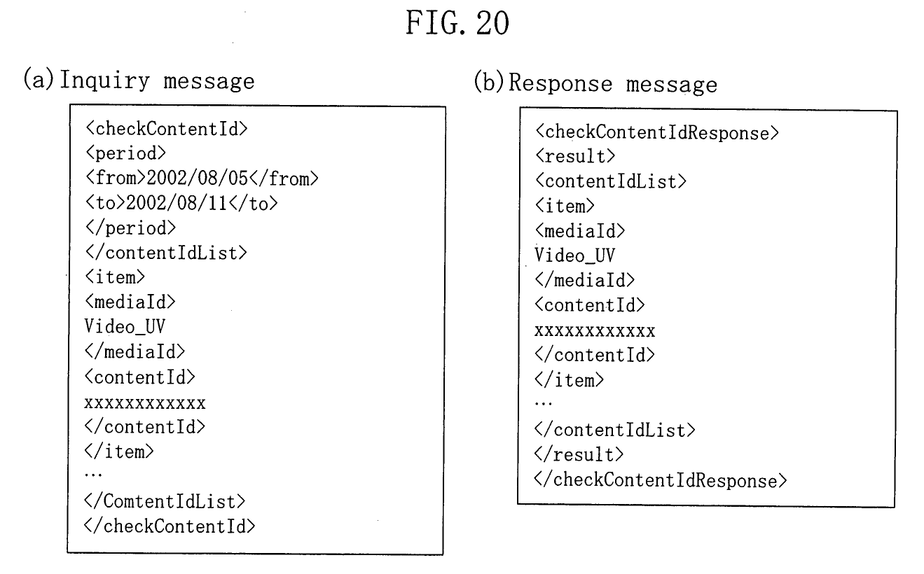

FIG. 20(a) is an illustration showing an exemplary inquiry message to be transmitted. FIG. 20(b) is an illustration showing an exemplary response message. In the inquiry message of FIG. 20(a), to reduce matching costs in the user agent 30 side, a viewing-and-listening period is designated, although the designation is redundant. The message <checkContentId> means to check whether or not a user viewed and listened to contents designated by <contentIdList> in a period designated by the <period> and return a list of viewed and listened to contents as <cntentIdList>. That is, the response message of FIG. 20(b) is obtained by removing items (media type identifiers and content identifiers) of contents which have not been viewed and listened to from the inquiry message <contentIdList>.

(Step c7)

The response tally section 47 interprets all of received response messages in order and tallies results. In this case, since “ranking” is designated in the condition input section 41, the number of contents having each content identifier in the response messages included in <contentIdList> is counted.

(Step c8)

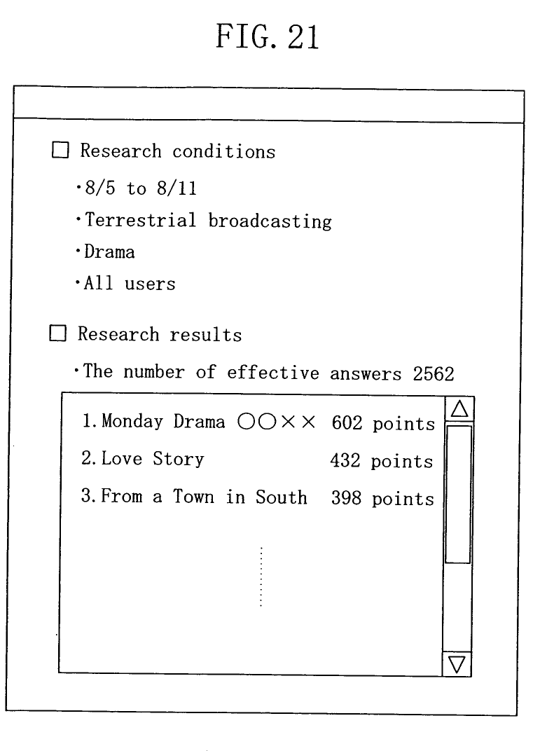

Based on the tally results in Step c7, for example, a list in which contents are put in decreasing order of the number of contents included in the response messages from the largest, i.e., in decreasing order of audience rating from the highest is output to a console display screen of the application server 13. FIG. 21 is an illustration showing an exemplary display of tally results. Note that some other media for file outputting, printing or the like may be designated as a media to which tally results are output.

As described above, if only an operator inputs research results from the console of the application server 13, it becomes possible to inquire of a plurality of user agents 30 viewing-and-listening histories to obtain research results. Which meta-information database 42 to be used may be freely selected in the service concierge 40 side. Also, interoperativity can be ensured only by using the same content identifier in the user agent 30 and the service concierge 40.

(Case 2: Content Recommendation)

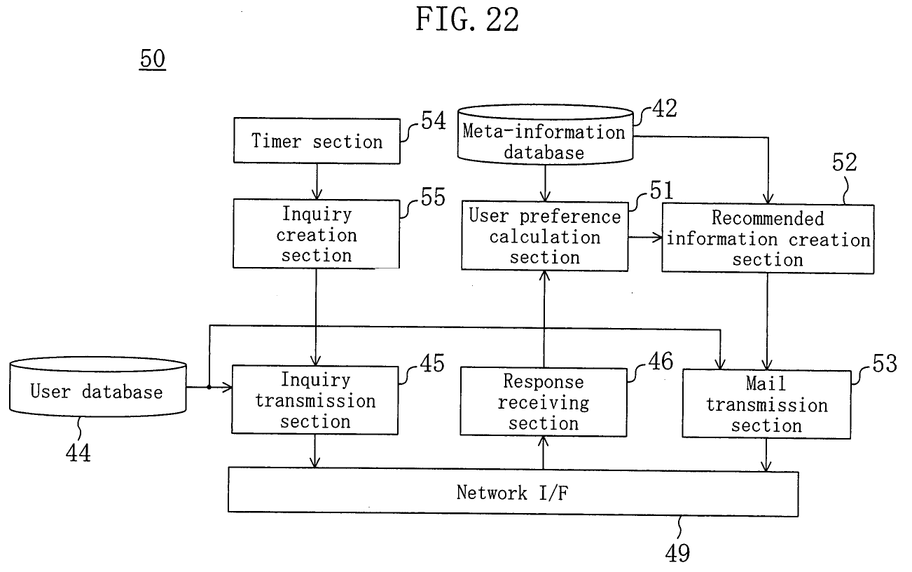

FIG. 22 is a block diagram illustrating the configuration of a service concierge 50 for performing content recommendation. In FIG. 22, each member also shown in FIG. 17 is identified by the same reference numeral and therefore the detail description thereof will be omitted. In FIG. 22, the reference numeral 51 denotes a user preference calculation section for analyzing response messages received by the response receiving section 46 with reference to the meta-information database 42 and calculating contents what kind of genres for contents a user is interested in; the reference numeral 52 denotes a recommended information creation section for extracting contents to be recommended based on a result of the user preference calculation section 51; the reference numeral 53 denotes a mail transmission section for transmitting the recommended information created by the recommended information creation section 52 to a mail address of a cellular phone and the like; the reference numeral 54 denotes a timer section for measuring an elapsed time since a counter has been reset; and the reference numeral 55 denotes an inquiry creation section for creating an inquiry message to the user agent 30. The meta-information database 42 stores attribute information for contents for each media type. Corresponding attribute information can be taken out by designating a media type identifier and a content identifier.

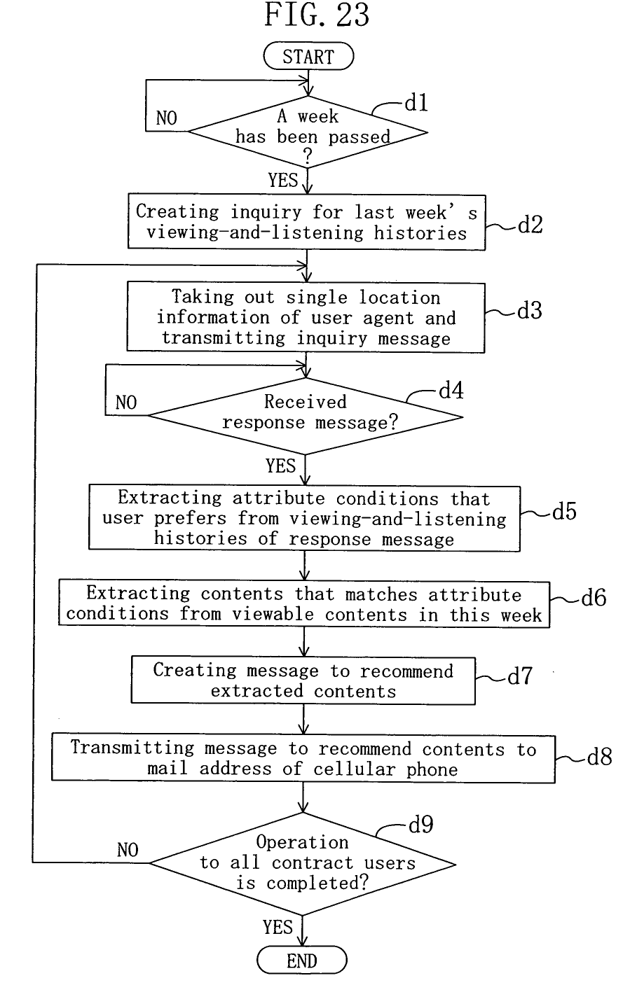

The operation of the service concierge 50 of FIG. 20 will be described with reference to a flow chart of FIG. 23. In this case, content viewing-and-listening histories stored by the user agent 30 are obtained every week to estimate a user's preference trend and recommended contents are transmitted to a mail address of a cellular phone.

(Step d1)

The inquiry creation section 55 examines whether or not a week has been passed from the last operation thereof. If a week has passed, the process proceeds with Step d2. If not so, after a predetermined standby time, Step d1 is executed again. In this case, the inquiry creation section 55 is operated at 0:00 a.m. every Monday. Even if the inquiry creation section 55 does not perform polling to the timer section 54, the inquiry creation section 55 may be driven by an event regularly caused by the timer section 54, instead.

(Step d2)

The inquiry creation section 55 creates an inquiry message for taking out viewing-and-listening history data from the previous Monday to Sunday.

(Step d3)

The inquiry transmission section 45 takes out, from the user database 44, single location information of the user agent 30 of a user having a contract for a distribution service for recommended contents information and transmits the inquiry message created in Step d2. In this case, the mail transmission section 53 takes out, from the user database 44, the mail address of the use's cellular phone and stores the mail address.

(Step d4)

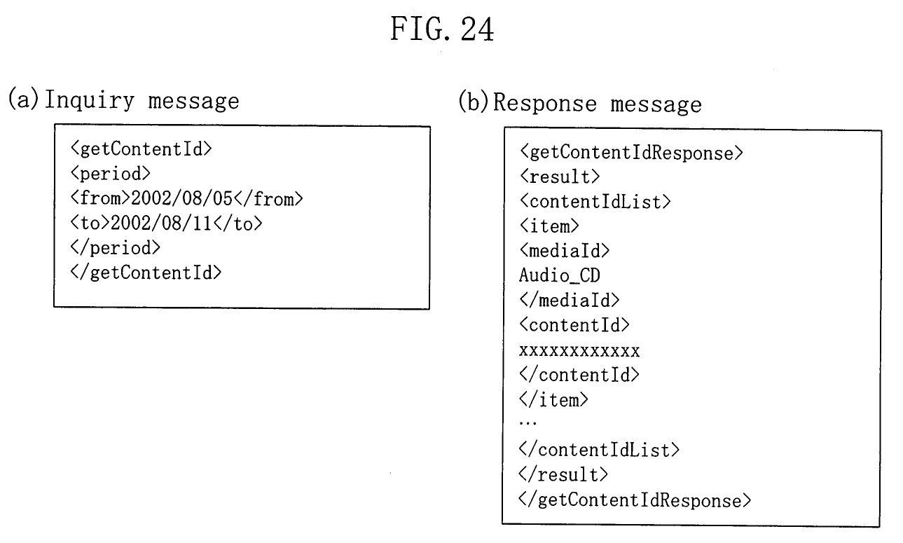

The response receiving section 46 examines whether or not the response message has been received from the user agent 30 which has transmitted the inquiry message. If the response message has been received, the process proceeds with Step d5. If not so, with a predetermined interval, Step d4 is executed again. FIG. 24 is an illustration showing an exemplary inquiry message and an exemplary response message. FIG. 24(a) shows an inquiry message created at 0:00 a.m. on the 12 Aug., 2002.

(Step d5)

The user preference calculation section 51 calculates a user's preference using content identifiers contained in the response message received in Step d4. Specifically, attribute information of viewed and listened to contents are examined with reference to the meta-information database 42 and the frequency of appearance of each attribute value is calculated for each attribute, thereby extracting attribute conditions of contents that the user is interested in. Thus, a user preference trend in view of “genres”, “artists”, “keywords” and the like can be obtained. Besides, “whether or not any contents recommended in the previous week has been actually watched?” can be taken into consideration. The service provider can achieve consistency in definitions of vocabularies among different media in the meta-information database 42, so that viewing-and-listening histories for a certain type of media can be utilized for content recommendation in some other media type.

(Step d6)

The recommended information creation section 52 performs a search in the meta-information database 42 to extract any contents that are viewable during a period from the 12 Aug., 2002 to the 18 Aug., 2002 and also match the extracted attribute conditions in Step d5.

(Step d7)

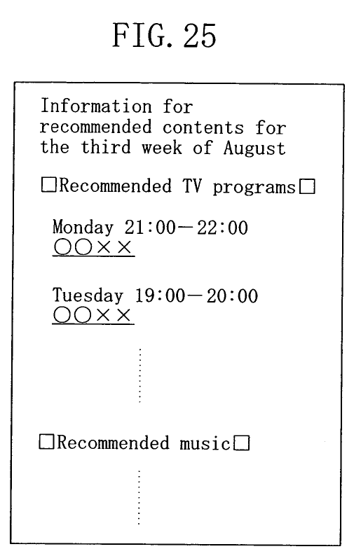

The recommended information creation section 52 creates a mail message to recommend the extracted contents in Step d6. FIG. 25 is an illustration showing an exemplary message. A title portion of contents may be made to be an anchor to be linked with information in the meta-information database 42 so that detailed information of contents can be easily referred to.

(Step d8)

The mail transmission section 53 transmits the message created in Step d7 to the mail address of the cellular phone stored in Step d3.

(Step d9)

Whether or not processing is completed to all registered uses is examined. If the processing is not completed, the process returns with Step d3 and the processing continuously performed. If the processing is completed, the counter of the timer section 54 is reset and the operation is terminated.

As described above, only by changing a program in the service concierge side, content recommendation and other various services can be provided. For example, if only users having a contract for a service are allowed to access to the device agent 20 from the service concierge 50, it is also possible to automate timer recording of recommended TV programs by transmitting a control message to the device agency 20 to the service concierge 50.

(Case 3: Automatic Content Management)

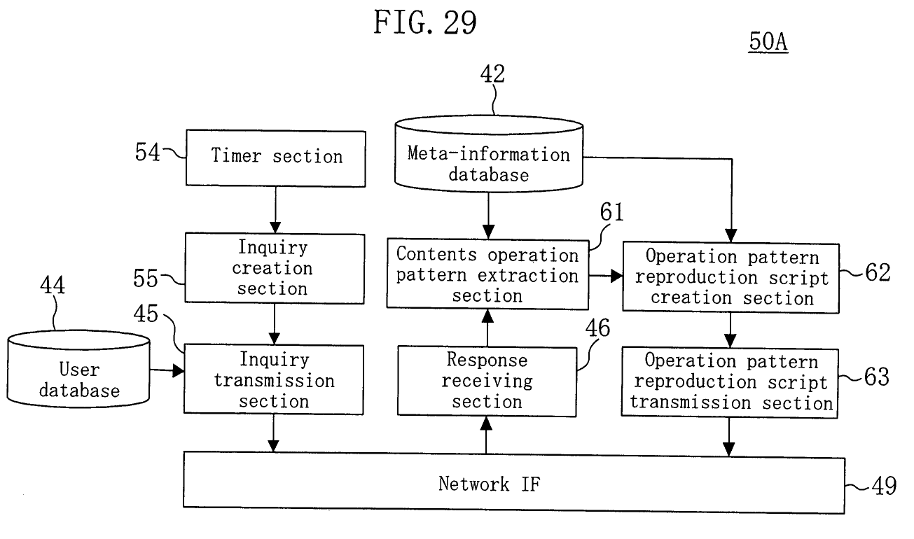

FIG. 29 is a block diagram illustrating the configuration of a service concierge 50A for providing a script for automatic content management. In FIG. 29, each member also shown in FIG. 22 is identified by the same reference numeral and therefore the detailed description thereof will be omitted. In FIG. 29, the reference numeral 61 denotes a content operation pattern extraction section for extracting, from content viewing-and-listening histories (e.g., for a month) included in a response message received by the response receiving section 46, a series of operation patterns performed to contents having the same identifier in a plurality of appliances such as a HDD recorder and a DVD recorder; the reference numeral 62 denotes an operation reproduction script generating section for specifying an operation pattern repeatedly applied to contents having a common attribute among operation patterns extracted by the content operation pattern extraction section 61 and generating a script, i.e., an operation pattern reproduction script, for automatically applying the specified operation pattern to other contents having the same attribute; and the reference numeral 63 denotes an operation pattern reproduction script transmission section for transmitting the operation pattern reproduction script generated by the operation pattern reproduction script generation section 62 to the user agent 30.

The user agent 30 interprets the transmitted operation pattern reproduction script and transmits an appliance control command included in the script to the corresponding device agent 20. Thus, a series of operation patterns to the contents are reproduced.

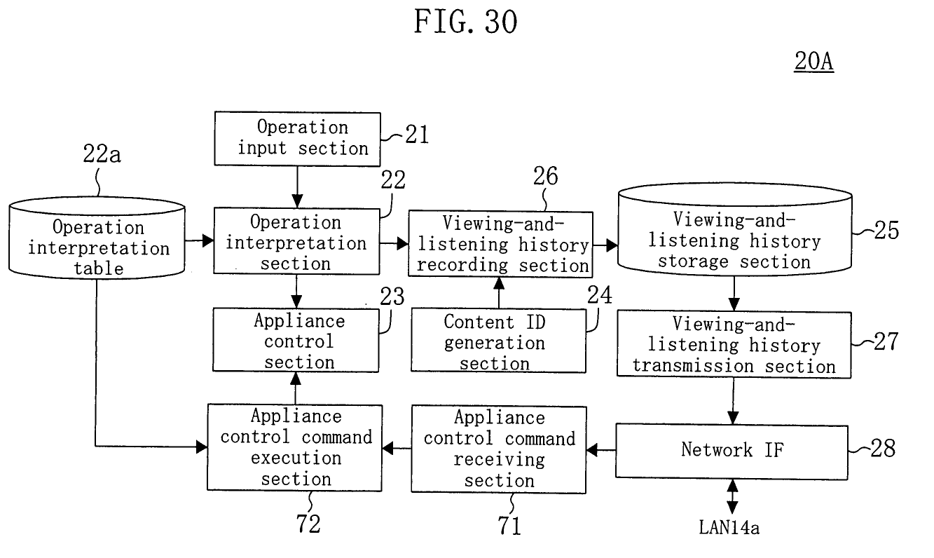

FIG. 30 is a block diagram illustrating the configuration of a device agent 20A in this embodiment. In FIG. 30, each member also shown in FIG. 3 is identified by the same reference numeral and therefore the detailed description thereof will be omitted. In FIG. 30, the reference numeral 71 denotes an appliance control command receiving section for receiving an appliance control command transmitted from the user agent 30 and the reference numeral 72 denotes an appliance control command execution section for interpreting, using an operation interpretation table 22a, the appliance control command received by the appliance control command receiving section 71 and controlling the appliance by the appliance control section 23.

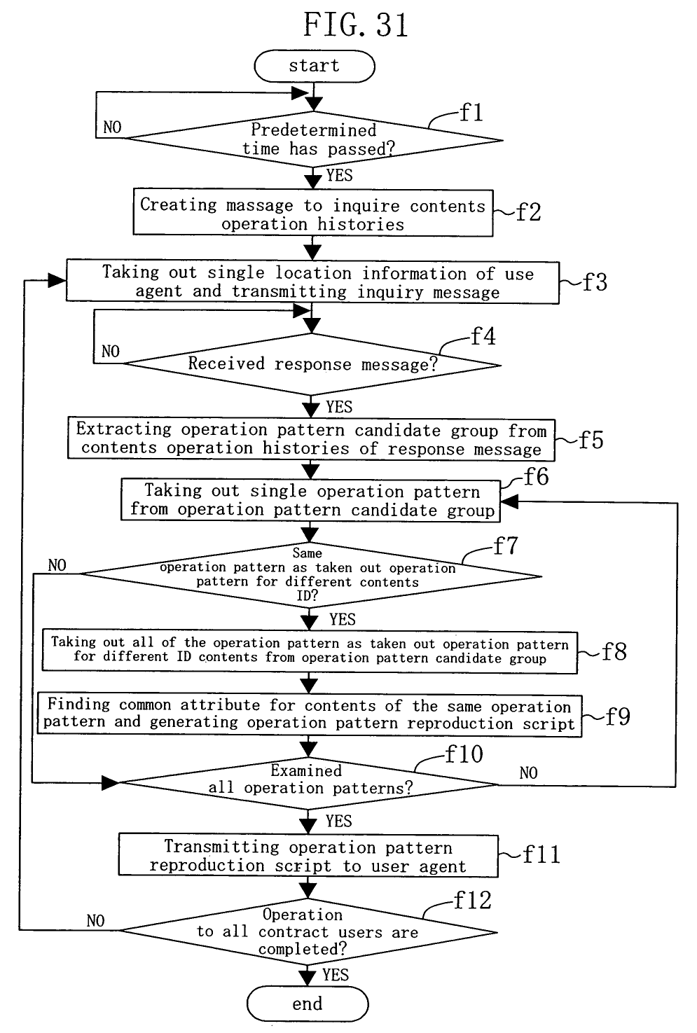

The operation of the service concierge 50A of FIG. 29 will be described with reference to a flow chart of FIG. 31. In this case, content viewing-and-listening histories stored by the user agent 30 are obtained every month, an operation pattern that a user repeatedly performs to contents having a specific attribute, and a script for automatically managing contents is generated and transmitted to the user agent 30.

(Step f1)

The inquiry creation section 55 examines whether or not a month has passed from the previous operation thereof with reference to the timer section 54. If a month has passed, the process proceeds with Step f2. If not so, after a predetermined standby time, Step f1 is executed again. In this case, the inquiry creation section 55 is operated at 0:00 a.m. on the 1^{st} of every month. Note that even if the inquiry creation section 55 does not perform poling to the timer 54, the inquiry creation section 55 may be driven by an event regularly caused by the timer section 54, instead.

(Step f2)

The inquiry creation section 55 generates an inquiry message used for taking out viewing-and-listening history data of the previous month.

(Step f3)

The inquiry transmission section 45 takes out single location information of the user agent 30 of a user having a contract for a distribution service for automatic content management script and transmits the inquiry message generated in Step f2. At this time, the operation pattern reproduction script transmission section 63 stores the location information of the user agent 30 that has transmitted the inquiry message.

(Step f4)

The response receiving section 46 examines whether or not the response message from the user agent 30 that has transmitted the inquiry message has been received. If the response message has been received, the process proceeds with Step f5. If not so, with a predetermined interval, Step f4 is executed again.

(Step f5)

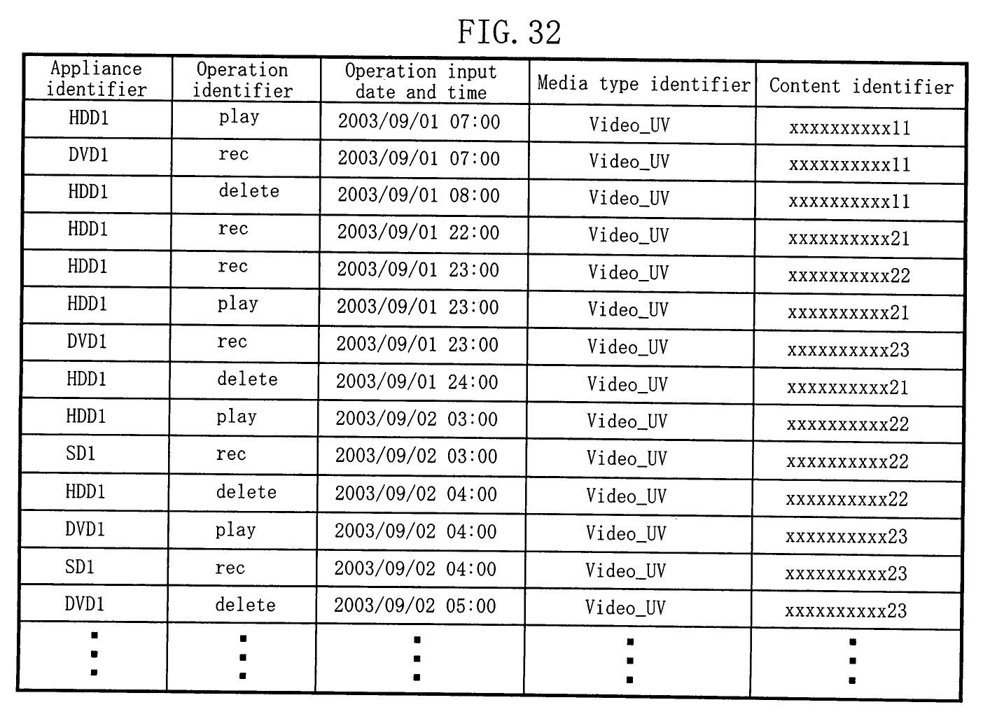

The content operation pattern extraction section 61 extracts, as an operation pattern candidate group, a series of operation patterns performed to contents having the same identifier in a plurality of appliances such as a HDD recorder and a DVD recorder from the content viewing-and-listening histories for a month included in the response message received in Step f4. For example, a series of operations which have been performed to contents “xxxxxxxxxx11” and are to be temporarily recorded in a HDD recorder and transferred to a DVD are extracted from viewing-and-listening histories of FIG. 32.

(Step f6)

A single operation pattern is taken out from the operation pattern candidate group extracted in Step f5.

(Step f7)

Whether or not a similar operation pattern to the taken out operation pattern is included in the operation pattern candidate group is examined. If the same operation pattern is found, the process proceeds with Step f8. If not so, the process proceeds with Step f10.

(Step f8)

Similar operation patterns for different content IDs are all taken out from the operation pattern candidate group. For example, in the viewing-and-listening histories of FIG. 32, operations for contents “xxxxxxxxxx22” and contents “xxxxxxxxxx23” are considered to be similar in the point that contents are recorded in an appliance and then transferred to a potable SD video player.

(Step f9)

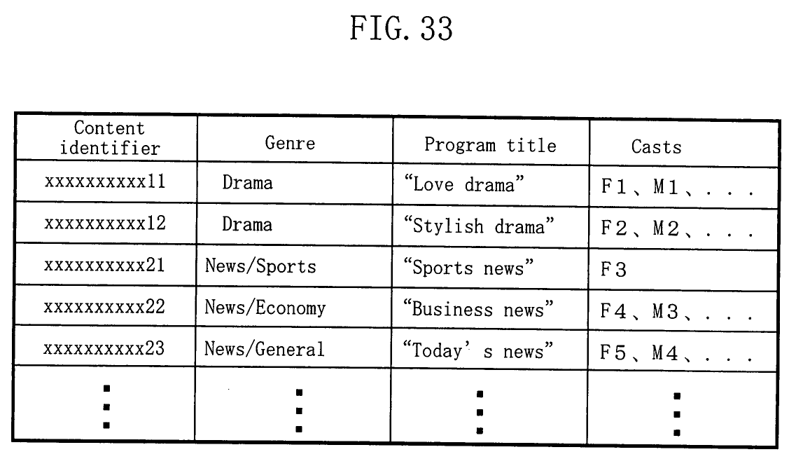

A common attribute is found in respective contents of the similar operation patterns taken out in Step f8 and an operation pattern reproduction script is generated. Assume that data shown in FIG. 33 is stored in the meta-information database 42. In the case described above, “news” can be specified as a common attribute for the contents “xxxxxxxxxx22” and the contents “xxxxxxxxxx23”. Then, as the operation pattern reproduction script, “whether or not contents stored in a HDD or a DVD are of ‘news’” is examined and, if the contents are of ‘news’, the contents are transferred to a portable SD player by the morning” is generated.

(Step f10)

If operation patterns of the operation pattern candidate group extracted in Step f5 have been all examined, the process proceeds with Step f11. If not so, the process proceeds with Step f6 and the operation is repeated.

(Step f11)

The operation pattern reproduction script transmission section 63 transmits the operation pattern reproduction script generated in Step f9 to the location information of the user agent 30 of the user stored in Step f3.

(Step S12)

Whether or not processing is completed to each of all registered users is examined. If the processing is not completed, the process returns with Step f3 and the processing is continuously performed. If the processing is completed, the counter of the timer section 54 is reset and the operation is terminated.

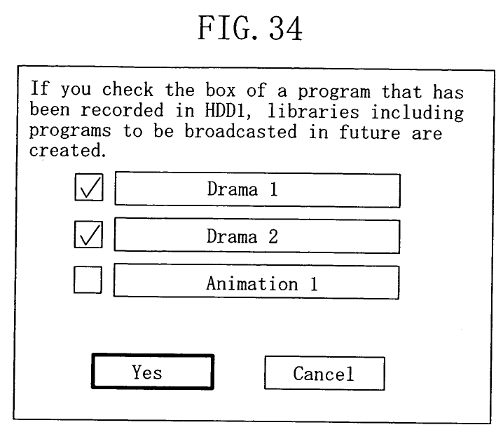

As described above, by finding operation patterns that a user repeatedly performs to contents of a specific type and automating the operation patterns, procedures for managing contents can be largely reduced. In this example, recorded news, which has not been viewed and listened to, is automatically transferred to a potable SD player. For users who create libraries of recorded contents in many cases, the function of allowing a user to make a selection as an exemplary screen of FIG. 34 can be additionally provided by applying the operation pattern reproduction script.

The service concierge may be incorporated in a home server system. With the service concierge incorporated in the home server system, the operation described above can be performed with reference to an EPG database obtained through the Internet or a broadcast wave.

In the service concierge side, the operation pattern reproduction script commonly used for many users can be extracted. For example, if a service for distributing a script extracted in the manner described above to a user who has newly bought an appliance is provided, the user can enjoy the same level of utility value as that for users who well handle the same kind of appliance with minimum efforts.

<Method for Judging Whether Program has Been Viewed and Listened to>

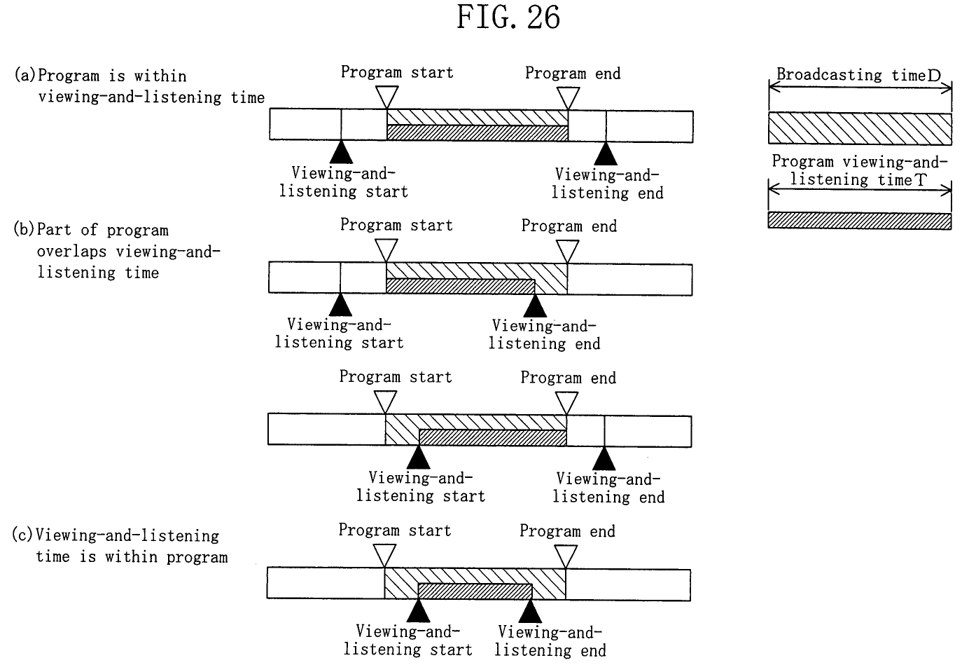

For contents (program) of the stream system, it is very rare that a viewing-and-listening start/end time completely matches a program start/end time. In most cases, there is a time rag between the viewing-and-listening start/end time and the program start/end time. For example, as shown in FIG. 26, there are the case (a) where a program is within a viewing-and-listening time, the case (b) where part of a program overlaps with a viewing-and-listening time, and the case (c) where a viewing-and-listening time is within a program.

Then, whether or not a user has actually viewed and listened to contents is judged, for example, in the flowing manner. Assume that where it is assumed that a broadcast time is D and a viewing-and-listening time is T,
T/D>C
holds. Specifically, when the ratio of the viewing-and-listening time T to the broadcast time D exceeds a predetermined value C, it is judged that the contents have been viewed and listened to. The predetermined value C is set to be, for example, 0.8 (80%).

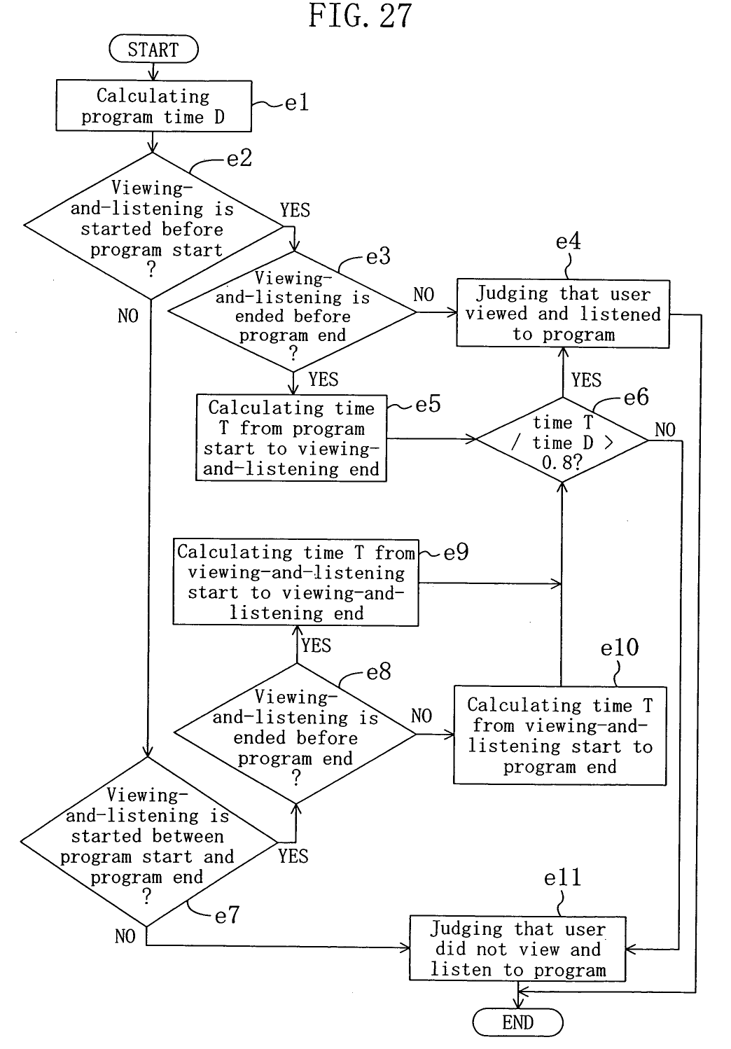

FIG. 27 is a flow chart showing the method for judging whether a user viewed and listened to a program according to this embodiment. First, the program time D is calculated (e1). If a viewing-and-listening is started before a program starts (yes in e2) and the viewing-and-listening is ended after the program ends (no in e3), it is judged that a user has viewed and listened to the program (e4). If a viewing-and-listening is started before a program starts (yes in e2) and the viewing-and-listening is ended before the program ends (yes in e3), a time from the start of the viewing-and-listening to the end of the viewing-and-listening is calculated as the viewing-and-listening time T (e5). If the ratio of the time T to the time D exceeds a predetermined value (i.e., 0.8 in this case) (yes in e6), it is judged that the user has viewed and listened to the program (e4). On the other hand, if the ratio does not exceeds the predetermined value (no in e6), it is judged that the user has not viewed and listened to the program (e11).

Moreover, assume that the viewing-and-listening is started after the program starts (no in e2) and between the start and end of the program (yes in e7). If the viewing-and-listening is ended before the program ends (yes in e8), a time from the start of the viewing-and-listening to the end of the program is calculated as the viewing-and-listening time T (e9). On the other hand, if the viewing-and-listening is ended after the program ends (no in e8), a time from the start of the viewing-and-listening to the end of the program is calculated as the viewing-and-listening time T (e10). Then, if the ratio of the time T to the time D exceeds the predetermined value (yes in e6), it is judged that the user has viewed and listened to the program. If the ratio does not exceed the predetermined value (no in e6), it is judged that the user has not watched the program (e11). Also, if the viewing-and-listening is started after the program ends (no in e7), it is judged that the user has not watched the program (e11).

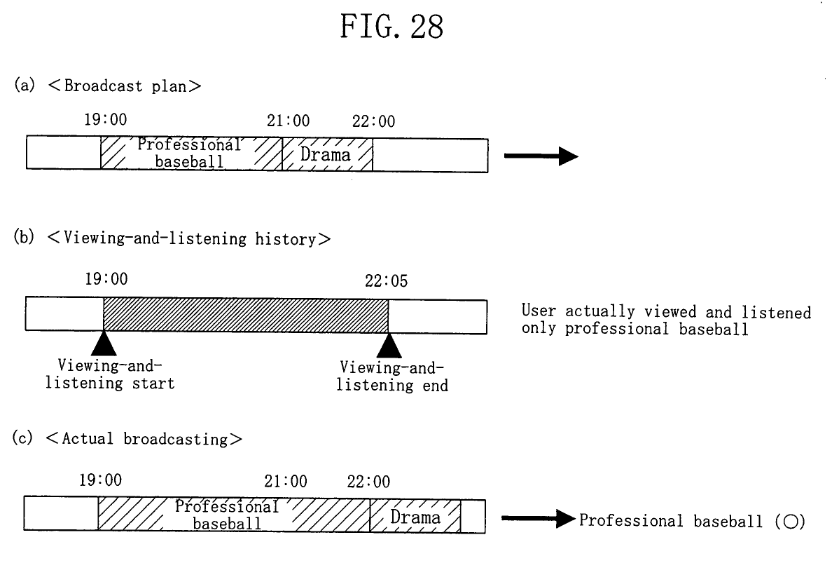

Furthermore, in the case of contents of the stream system, a broadcast time of a program is often changed, for example, because of extended live broadcast of a baseball game or a special report program. In such a case, if a program listing after a program ends is used, content viewing-and-listening history data can be interpreted according to an actual broadcasting. For example, as shown in FIG. 28, assume that in a broadcast plan, a “professional baseball game” is to be broadcasted from 19:00 to 21:00 and a “drama” is to be broadcasted from 21:00 to 22:00 (a). If in the viewing-and-listening history data, the time of start of a viewing-and-listening is 19:00 and a time of end of the viewing-and-listening is 22:00 (b), it is judged that a user has viewed and listened to the “professional baseball game” and the “drama” as contents. However, if a live broadcast of the professional baseball game has been actually extended until 22:00 (c), the user has only watched the “professional baseball game” but has not watched the “drama”. Thus, precise viewing-and-listening histories can not be achieved. To avoid this problem, in the service concierge, viewing-and-listening history data can be appropriately changed using the program listing after the broadcast.

As described above, according to the present invention, each of the roles of recording histories, collecting and managing histories and analyzing histories is formed as an independent module of the device agent, the user agent or the service concierge. Thus, a flexible operation is allowed, e.g., it is possible to make a single system have a plurality of roles and to have viewing-and-listening histories commonly used by services incorporated in electric appliances and services provided via the Internet.

Moreover, by providing an access from the service provider side to viewing-and-listening histories in the form of an inquiry from the service concierge to the user agent, the access to the viewing-and-listening histories can be controlled according to a circuit capacity and a privacy protection policy.

Furthermore, content viewing-and-listening histories in electric appliances that a user owns are stored using media identifiers and content identifiers. Thus, interoperability between the service side and the viewing-and-listening history storage side can be increased. Moreover, vocabularies at the meta-information level that are difficult to be standardized are not contained in a viewing-and-listening history database. Thus, various venders can provide services fully utilizing content viewing-and-listening histories by freely designing the service concierge using unique meta-information with a high degree of detail and the like.

1. A viewing-and-listening history recording method for recording content viewing-and-listening history data in an electric appliance used for viewing and listening to contents, the method comprising the steps of:
interpreting an operation performed to the electric appliance by a user and extracting a content viewing-and-listening operation;
acquiring a content identifier for contents according to the extracted content viewing-and-listening operation; and
specifying viewing-and-listening date and time for the contents from the extracted content viewing-and-listening operation and recording the specified viewing-and-listening date and time and the content identifier in a group as viewing-and-listening history data in a viewing-and-listening history storage section.

2. A viewing-and-listening history utilization method for utilizing content viewing-and-listening histories in a plurality of appliances, the method comprising the steps of:
extracting, from content viewing-and-listening history data for contents specified by a common identifier in the plurality of appliances, a series of operation patterns performed to contents having the same identifier in the plurality of appliances;
specifying, from the extracted operation patterns, an operation pattern commonly performed to contents having a common attribute; and
creating an operation reproduction script for applying the specified operation pattern to other contents having the attribute.
